(19) United States
(12) Patent Application Publication
(10) Pub. No.: US 2006/0184950 A1
(43) Pub. Date: Aug. 17, 2006

(54) Disc drive

(75) Inventors: Toshiyuki Kaneko, Tokorozawa-shi (JP); Keiichi Takagi, Tokorozawa-shi (JP); Yuji Yamada, Tokorozawa-shi (JP); Naozumi Teramoto, Tokorozawa (JP); Kouichi Yaeguchi, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo, Japan

(21) Appl. No.: 11/092,980

(22) Filed: Mar. 30, 2005

(30) Foreign Application Priority Data
Mar. 30, 2004 (JP) 2004-099139

(51) Int. Cl. G11B 17/04

(52) U.S. Cl. 720/601

(57) ABSTRACT

When an optical sensor 410 disposed near an opening of a casing 10 (translator's comment: correctly, 110) detects an optical disc 10, a disc processing section 200 is rotated to a retracted position where a rotating shaft 222A is retracted from the moving path of the optical disc 10. When the optical disc 10 moves to a certain position from the opening, the loading unit 400 loads the optical disc 10. When the optical disc 10 is located at a loading-completion position, a sensing switch 420 is turned off, and the disc processing section 200 is rotated to an advanced position where the rotating shaft 222A is advanced onto the moving path to rotatably support the optical disc 10. In response to a request for ejecting the optical disc 10, the disc processing section 200 is rotated to the retracted position to release the rotatably supporting state and the loading unit 400 is activated to eject the optical disc 10. The disc processing section 200 is rotated to the advanced position if the optical sensor 410 is no longer able to detect the optical disc 10.

### BACKGROUND OF THE INVENTION

1. Field of the Invention

The present invention relates to a disc drive that performs an information processing of at least one of an information reading for reading out information recorded on a recording surface of a disc recording medium and an information recording for recording various pieces of information on the record (translator's comment: correctly, recording surface).

2. Description of Related Art

Conventionally, a slot-in type disc drive has been known as such kind of disc drive, which automatically loads a disc recording medium to a prespecified processing position when the disc recording medium is inserted to a certain position by a user. Since the slot-in type disc drive constantly allows the user to insert the disc recording medium, a supporting portion, which rotatably supports the disc recording medium to be rotated during information processing, is retracted from the position for information processing so that the disc recording medium to be inserted will not contact to the supporting portion. When the disc recording medium is inserted and loaded to the certain position, the supporting portion moves the disc recording medium to the position for information processing and rotatably supports it.

Incidentally, disc drives have been desired to be downsized due to downsizing of recent information-processing equipments. Especially, downsizing has strongly been requested on portable personal computers or the like. Owing to this, in the case where the entire dimension is designed smaller, the supporting portion becomes closer to the casing when being retracted from the position for information processing. There is an exemplary problem that, when having impact from the outside in this state, the supporting portion, a configuration for moving the supporting portion, various kinds of components provided on that configuration and the like will contact to the casing and may be damaged.

### SUMMARY OF THE INVENTION

Considering the above-described situation, an object of the present invention is to provide a disc drive to be easily downsized.

A disc drive according to an aspect of the present invention includes: a casing having an opening through which a disc recording medium is inserted or ejected; an operating section disposed in the casing and having a supporting portion for rotatably supporting the disc recording medium, the supporting portion being advanced onto and retracted from a moving path of the disc recording medium; an information processing section provided in the casing to perform an information processing of at least one of an information reading for reading out various pieces of information recorded on a recording surface of the disc recording medium and an information recording for recording various pieces of information on the recording surface; a disc detector provided near the opening of the casing to detect is the presence of the disc recording medium; a loading detector provided in the casing to detect that the disc recording medium is substantially located at a loading-completion position at which the information processing section can perform the information processing; and an operating section controller that moves the operating section so that the supporting portion is retracted from the moving path when recognizing that the disc detector detects the disc recording medium and moves the operating section so that the supporting portion is advanced onto the moving path when recognizing that the loading detector detects the loading-completion position and that the disc detector cannot detect the disc recording medium.

A disc drive according to another aspect of the present invention includes: a casing having an opening through which a disc recording medium is inserted or ejected; an operating section disposed in the casing and having a supporting portion for rotatably supporting the disc recording medium, the supporting portion being advanced onto and retracted from a moving path of the disc recording medium; an information processing section provided in the casing to perform an information processing of at least one of an information reading for reading out various pieces of information recorded on a recording surface of the disc recording medium and an information recording of recording various pieces of information on the recording surface; a disc detector disposed at a position near the opening of the casing where the disc recording medium is detected when the disc recording medium is located on the moving path and the disc recording medium cannot be detected when the disc recording medium is located at a loading-completion position where the information processing section can perform the information processing; and an operating section controller that moves the operating section so that the supporting portion is retracted from the moving path when the disc detector detects the disc recording medium and moves the operating section so that the supporting portion is advanced onto the moving path when the disc detector cannot detect the disc recording medium.

A disc drive according to yet another aspect of the present invention includes: a casing having an opening through which a disc recording medium is inserted or ejected; an operating section disposed in the casing and having a supporting portion for rotatably supporting the disc recording medium, the supporting portion being advanced onto and retracted from a moving path of the disc recording medium; an information processing section provided in the casing to perform an information processing of at least one of an information reading for reading out various pieces of information recorded on a recording surface of the disc recording medium and an information recording for recording various pieces of information on the recording surface; and an operating section controller that moves the operating section so that the supporting portion is advanced onto the moving path to rotatably support the disc recording medium when detecting that the disc recording medium is not on the moving path and the disc recording medium is located at a loading-completion position at which the information processing section can perform the information processing, and moves the operating section so that the supporting portion is retracted from the moving path when the disc recording medium is moving on the moving path.

A slot-in type disc drive according to a further aspect of the present invention includes: a disc sensor provided near an opening to sense whether a disc is inserted or not; a loading detector that senses loading-completion state of the disc; a disc loading and unloading determiner that determines whether the disc is inserted or ejected according to a detection result by the disc sensor whether the disc is inserted or not and by the loading detector whether the disc loading is completed or not; and a supporting portion rotatably supporting the disc, in which the supporting portion is retracted when the insertion of the disc is sensed, and is advanced when the ejection of the disc is sensed by the disc loading and unloading unit (translator's comment: correctly, disc loading and unloading determiner).

### BRIEF DESCRIPTION OF THE DRAWINGS

### Brief Description of the Drawings

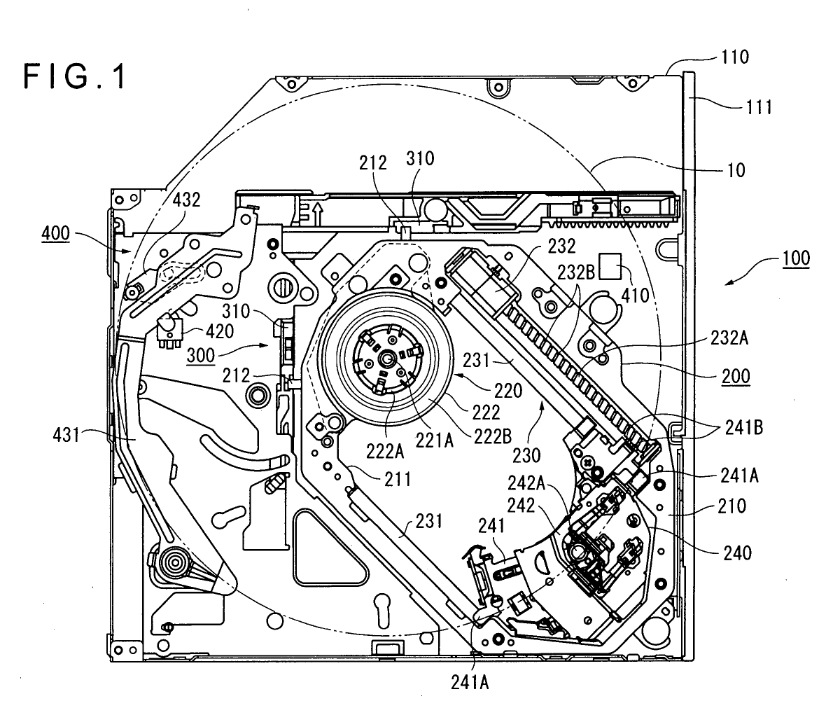

FIG. 1 is a plan view showing a disc drive according to a first embodiment of the present invention with a part thereof being cut;

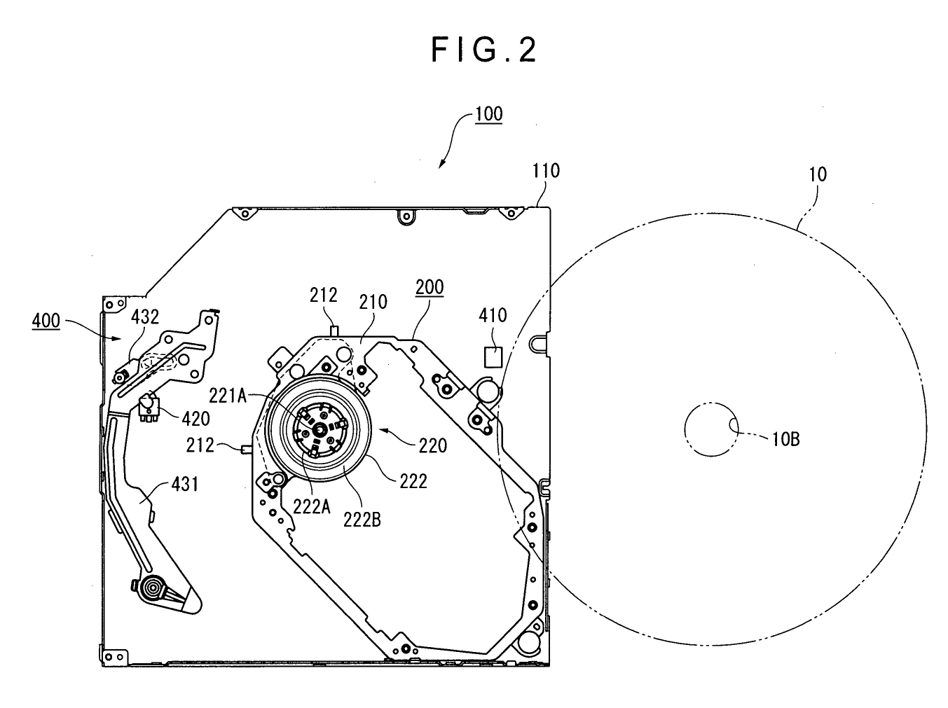

FIG. 2 is a plan view showing a configuration of the disc drive during insertion standby state of an optical disc according to the first embodiment with a part thereof being cut;

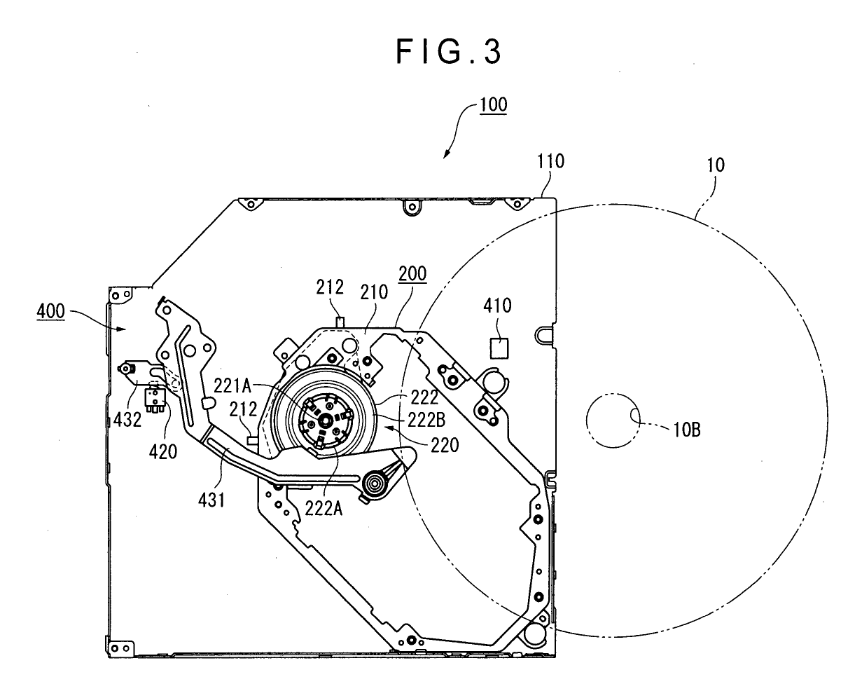

FIG. 3 is a plan view showing a configuration of the disc drive at the beginning of insertion or before completion of ejection of the optical disc according to the first embodiment with a part thereof being cut;

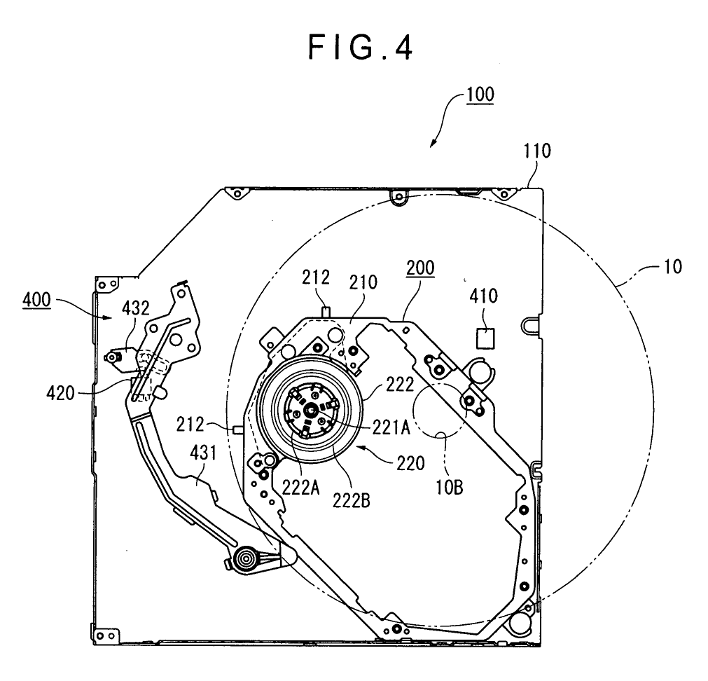

FIG. 4 is a plan view showing a configuration of the disc drive before completion of insertion or at the beginning of ejection of the optical disc according to the first embodiment with a part thereof being cut;

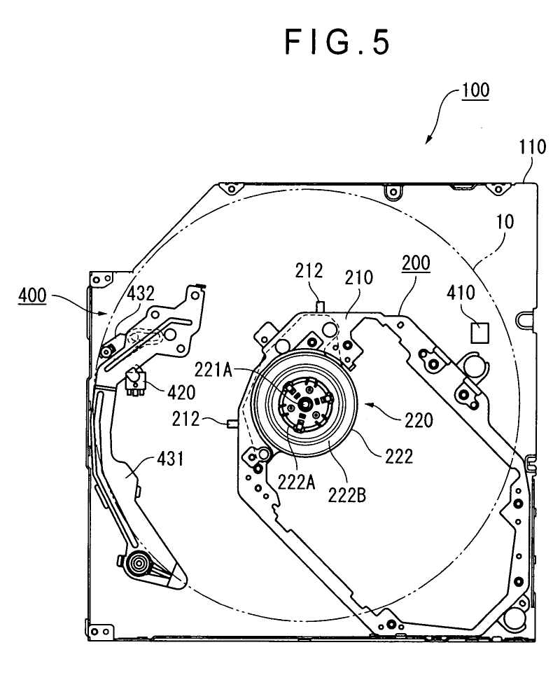

FIG. 5 is a plan view showing a configuration of the disc drive when the optical disc is positioned at the loading-completion position according to the first embodiment with a part thereof being cut;

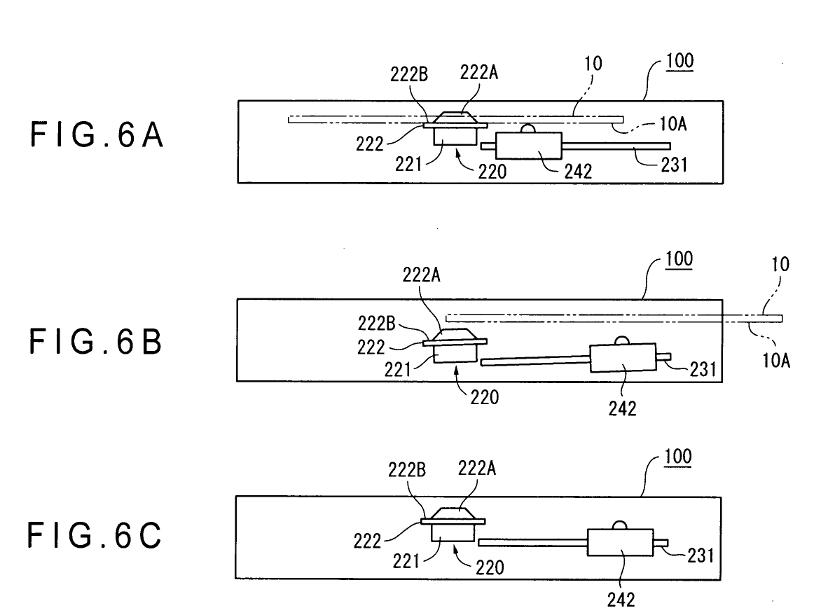

FIGS. 6A to 6C are explanatory illustrations each explaining rotation state of a disc processing section of the disc drive according to the first embodiment, in which FIG. 6A is a conceptual diagram showing the state when the optical disc is positioned at the loading-completion position corresponding to the state shown in FIG. 5, FIG. 6B is a conceptual diagram showing the state when the optical disc is inserted or ejected corresponding to the state shown in FIGS. 3 and 4, and FIG. 6C is a conceptual diagram showing insertion standby state corresponding to the state shown in FIG. 2; and

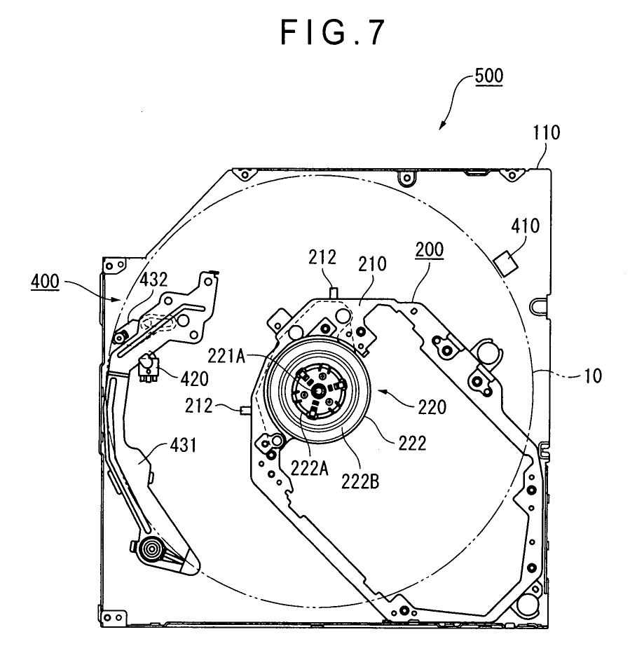

FIG. 7 is a plan view showing a disc drive according to a second embodiment of the present invention with a part thereof being cut.

### DETAILED DESCRIPTION OF PREFERRED EMBODIMENT(S)

### First Embodiment

A first embodiment of the present invention will be described below with attached drawings. In the present embodiment, a slot-in type disc drive that records information on and reads out information from an optical disc as a disc recording medium is described as an example, however, the disc drive may only read out or record information. The disc recording medium is not limited to the optical disc, and may be any kind of disc recording medium such as a magnetic disk or magnetooptical disk. Additionally, while the thin slot-in type drive installed in an electric equipment such as a portable personal computer is exemplified here, a stand-alone configuration is also available like a game console or a reproducing device for recording and reproducing video data. The configuration is not even limited to be thin.

(Structure of Disc Drive)

In FIGS. 1 to 5, a disc drive 100 is so-called a thin slot-in type installed in an electric equipment such as a portable personal computer, which performs information processing for reading out information recorded on a recording surface 10A of an optical disc 10 as a disc recording medium and recording various pieces of information on the record (translator's comment: correctly, recording surface 10A). Note that, a part of the configuration for a disc processing section is omitted in FIGS. 2 to 5 for simple description.

The disc drive 100 has a box-like casing 110, which is for instance made of metal and has a space inside. A decorative plate 111 is provided on a lateral surface of the casing 110, the decorative plate 111 being made of synthetic resin formed in an elongated plate. A slit-like opening (not shown) is provided in the decorative plate 111 in longitudinal direction. Disposed in the casing 110 are a disc processing section 200 which is so-called a traverse mechanism, a driving section 300 for moving the disc processing section 200, a loading unit 400 for loading the optical disc 10, and a control circuit (not shown) in which an operating section controller functioning as an ejection detector and a disc loading and unloading unit (translator's comment: correctly, disc loading and unloading determiner) is installed. An operating section of the present invention is thus constituted by the disc processing section 200 and the driving section 300.

The disc processing section 200 has a mount 210 as a rotating body made of a metallic plate in a flat octagonal shape in plan view. A cutout portion 211 is formed substantially at the center of the mount 210 to be a frame. As shown in FIG. 1, a disc rotation driver 220 is arranged near the peripheral edge of the mount 210 at an end in longitudinal direction. As shown in FIG. 6, the disc rotation driver 220 includes an electric rotating motor 221 such as a spindle motor and a turn table 222 integrally formed with an output shaft 221A of the electric rotating motor 221. The electric rotating motor 221 is controllably connected to the control circuit and driven upon the electric power supplied from the control circuit. The turn table 222 includes a substantially cylindrical rotating shaft 222A, which is a supporting portion inserted and fit to an axial hole 10B formed at the center of the optical disc 10 for rotatably supporting the optical disc 10, and a collar 222B projecting in flange shape on the outer circumferential surface of the rotating shaft 222A so that the peripheral edge of the axial hole 10B of the optical disc 10 is put thereon to be held thereby.

Additionally, a processor moving unit 230 is disposed on the mount 210. The processor moving unit 230 has a pair of guide shafts 231 and an electric moving motor 232 such as a stepping motor. The pair of guide shafts 231 is, for example, a metallic thin rod and is disposed near the inner circumference of the cutout 211 of the mount 210 with the axial direction thereof being substantially in parallel along the longitudinal direction of the mount 210. The electric moving motor 232 is controllably connected to the control circuit and driven upon the electric power supplied from the control circuit. The electric moving motor 232 is disposed so that the axial direction of the output shaft 232A is along the axial direction of the guide shaft 231. An engaging groove 232B is formed in a spiral manner on the outer circumferential surface of the output shaft 232A of the electric moving motor 232.

An information processing section 240 supported by the processor moving unit is disposed on the mount 210. The information processing section 240 has a movement holder 241 held by the pair of guide shafts 231 in a bridged state. The movement holder 241 is provided with a holder 241A to which the guide shafts 231 are movably inserted and fit, and a movement restricting claw 241B engaging with the engaging groove 232B of the output shaft 232A of the electric moving motor 232. Further, the movement holder 241 of the information processing section 240 is provided with a pickup 242 as an information processing section including a light source (not shown), a lens 242A for converging the light from the light source, and an optical sensor (not shown) for detecting the light reflected by the optical disc 10. The pickup 242 connected to the control circuit capable of sending/receiving signals reads out various pieces of information recorded on the recording surface 10A of the optical disc 10 to output information to the control circuit and records various pieces of information from the control circuit on the recording surface under the control of the control circuit.

In the disc processing section 200, a cover (not shown) is integrally attached the mount 210 as covering, some portions of the cover being cut corresponding to the moving path of the pickup 242 and the turn table 222. The disc processing section 200 is rotatably supported by the casing 110 at the other end so that an end side of the mount 210 in longitudinal direction with the turn table 222 provided can rotate in the direction substantially along the axial direction of the rotating shaft 222A.

As shown in FIG. 1, the driving section 300 includes in the casing 110 a motor (not shown), for example, controllably operated by the control circuit, and a moving cam 310 moved by the drive of the motor. The moving cam 310 engages with the motor as well as the engaging claw 212 projecting outside from the mount 210 to be moved by the drive of the motor for rotating the mount 210. The rotation of the mount 210 represents the state that the rotating shaft 222A of the turn table 222 is advanced onto and retracted from the moving path where the optical disc 10 is loaded by the loading unit 400. Specifically, the mount 210 is rotated between an advanced position shown in FIGS. 6A and 6C in which the rotating shaft 222A of the turn table 222 is advanced onto the moving path of the optical disc 10 and a retracted position shown in FIG. 6B in which the rotating shaft 222A of the turn table 222 is retracted from the moving path of the optical disc 10 to stand by.

As shown in FIG. 1, the loading unit 400 includes in the casing 110 a loading motor (not shown), for example, controllably operated by the control circuit, a linking mechanism (not shown) interlocked upon the drive of the loading motor, an optical sensor 410 as a disc detector and a sensing switch 420 as a loading detector. The linking mechanism has a sensor arm 431, an interlocked arm 432 and a loading arm (not shown). The sensor arm 431, the interlocked arm 432 and the loading arm are, for example, made of metal and formed in elongated plates, respective ends of which in longitudinal direction are rotatably supported by the casing 110. The sensor arm 431 and the interlocked arm 432 are rotatably supported and coupled to each other at the intermediate portions of these in longitudinal direction, so that the interlocked arm 432 is rotated as the sensor arm 431 rotates. The loading arm is disposed such that the other end can rotate inward near the opening of the casing 110, the other end contacting to the peripheral edge of the optical disc 10 to load the optical disc 10. Pulleys (not shown) are rotatably supported near tip ends of the sensor arm 431 and the loading arm in the rotation side, the center of the pulley in axial direction being formed small in diameter and the peripheral surface thereof contacting to the peripheral edge of the optical disc 10. The sensor arm 431 and the loading arm are able to move outside against the biasing force when a relatively strong force is applied thereto. To be more specific, the arms can rotate as these are pushed outside by the peripheral surface of the optical disc 10 when the optical disc 10 is pushed into the opening.

The optical sensor 410 is disposed, for instance, near the opening of the casing 110 at the position capable of immediately detecting the optical disc 10 to be inserted from the opening. The optical sensor 410 is also located at the position capable of detecting the optical disc 10 even at the loading-completion position (see FIGS. 5 and 6A) where the pickup 242 performs information processing for the disc. The optical sensor 410 detects is the presence of the optical disc 10 by detecting the outgoing light beam reflected by the optical disc 10 to be inserted from the opening. A signal indicating detection of the optical disc 10 is output to the operating section controller of the control circuit.

The sensing switch 420 to sense the loading-completion state of the optical disc 10 is disposed in the casing 110 and turned on/off owing to the rotation state of the interlocked arm 432. More specifically, the sensing switch 420 is turned off when the sensor arm 431 is located at the loading-completion position (see FIG. 5) which is the substantially same position as the standby position (see FIGS. 1, 2 and 5), and is turned on when the sensor arm 431 is in the rotating state (see FIGS. 3 and 4) other than at the positions described above. The on/off signals of the sensing switch 420 are output to the controlling section controller (translator's comment: correctly, the operating section controller) of the control circuit. According to the on/off signals of the sensing switch 420, the controlling section controller (translator's comment: correctly, the operating section controller) of the control circuit recognizes the loading-completion state of the optical disc 10. The loading-completion state means that the optical disc 10 is housed in the disc drive 100. The sensing switch 420 senses the loading-completion state.

The control circuit controls the entire operation of the disc drive 100. The operating section controller of the control circuit rotates the disc processing section 200 to the advanced position shown in FIGS. 6A and 6C in the standby state in which the optical disc 10 is loaded from the opening and the state in which the optical disc 10 has been loaded to the loading-completion position. The operating section controller also rotates the disc processing section 200 to the retracted position shown in FIG. 6B in the state in which the optical disc 10 is moving on the moving path when the optical disc 10 is loaded or ejected. In other words, the operating section controller determines whether the optical disc 10 is inserted or ejected according to the sensing status of the optical sensor 410 and the sensing switch 420, operates the disc processing section 200 with the turn table 222 rotatably supporting the optical disc 10 to be retracted from the moving path when recognizing insertion, and operates the disc processing section 200 to be advanced onto the moving path when recognizing ejection.

Specifically, when the optical sensor 410 detects the optical disc 10, the operating section controller drives the motor of the driving section 300 to move the moving cam 310 and to rotate the disc processing section 200 to the retracted position shown in FIG. 6B. Further, the operating section controller drives the loading motor to rotate the sensor arm 431 of the linking mechanism to the position shown in FIG. 3 and also to rotate the loading arm inward. The sensing switch 420 is turned on as the sensor arm 431 is rotated, the operating section controller recognizes that the optical disc 10 is moving on the moving path due to insertion or ejection.

When the optical disc 10 is loaded just before the loading-completion position shown in FIG. 5 from the state described above, the sensing switch 420 is turned off. When recognizing that the sensing switch 420 is turned off, the control circuit drives the motor of the driving section 300 to move the moving cam 310 and to start rotating the disc processing section 200 to the advanced position shown in FIG. 6A. When the optical disc 10 is loaded to the loading-completion position shown in FIG. 5 and the sensor arm 431 is located at the standby position to restrict the movement of the optical disc 10, the rotating shaft 222A of the turn table 222 of the rotating disc processing section 200 is inserted and fit to the axial hole 10B opened substantially at the center of the optical disc 10 and the optical disc 10 is rotatably supported by the turn table 222 as shown in FIG. 6A.

For example, when recognizing that an eject button etc., which requests the optical disc 10 to be ejected, is operated, the operating section controller drives the motor of the driving section 300 to move the moving cam 310, so that the disc processing section 200 is rotated to the retracted position shown in FIG. 6B. Because of that rotation, the rotating shaft 222A of the turn table 222 is released from the axial hole 10B of the optical disc 10. After the disc processing section 200 is rotated, the loading motor is driven to rotate the sensor arm 431 and to push out the optical disc 10, so that the optical disc 10 is ejected from the opening as shown in FIG. 3. Then, when the optical disc 10 is removed from the opening, the optical sensor 410 is no longer able to sense the optical disc 10. The operating section controller therefore recognizes that the optical disc 10 is not inserted, drives the loading motor to move the linking mechanism to the standby position as shown in FIG. 2, and drives the motor of the driving section 300 to move the moving cam 310 and to rotate the disc processing section 200 to the advanced position as shown in FIG. 6C, thereby becoming the insertion standby state for the optical disc 10.

(Operation of Disc Drive)

The operation of the disc drive 100 of the above-described embodiment will be described below.

First, the electric power is supplied to the disc drive 100 by turning on the power of the electric equipment. Owing to the electric power supply, the operating section controller of the control circuit determines the detection state of the optical disc 10, i.e. is the presence of the optical disc 10 according to the signal output from the optical sensor 410. Then, when recognizing that the optical sensor 410 detects the optical disc 10, the operating section controller determines that the optical disc 10 has been inserted already, and outputs the signal indicating insertion of the optical disc 10 to the circuit controlling the operation of the electric equipment. On the other hand, when recognizing that the optical sensor 410 does not detect the optical disc 10, the operating section controller determines as the loading standby state where the optical disc 10 is not inserted, thereby becoming the detection standby state for the optical disc 10 to be detected by the optical sensor 410. In the case where the pickup 242 is not located at the standby position, i.e. the rotation center side of the mount 210 which is the side opposite to the electric rotating motor 221, the control circuit drives the electric moving motor 232 to move the pickup 242 to the standby position.

When the optical sensor 410 detects the optical disc 10 in the loading standby state, the operating section controller drives the motor of the driving section 300 to move the moving cam 310 and to rotate the disc processing section 200 to the retracted position shown in FIG. 6B. Further, the operating section controller drives the loading motor to rotate the sensor arm 431 of the linking mechanism to the position shown in FIG. 3 and also to rotate the loading arm inward. When recognizing that the sensing switch 420 is turned on after the sensing switch is turned on due to rotation of the sensor arm 431, the operating section controller recognizes that the optical disc 10 is moving on the moving path for insertion or ejection, in other words, the optical disc 10 is located on the moving path.

If the optical disc 10 is pushed inside from the above-described state, the peripheral edge of the optical disc 10 contacts to the pulley of the sensor arm 431 as shown in FIG. 3. If the optical disc 10 is further pushed in this state, the sensor arm 431 and the loading arm are pushed out against the biasing force to be rotated outside. And if the optical disc 10 is pushed to the position shown in FIG. 4, the loading arm passes over the peripheral edge of the optical disc 10, and consequently, the biasing force is again applied to the loading arm to be rotated inward, so that the optical disc 10 is loaded to the loading-completion position by the biasing force.

When the optical disc 10 is loaded just before the loading-completion position shown in FIG. 5, the sensing switch 420 is turned off. When recognizing that the sensing switch 420 is turned off, the control circuit drives the motor of the driving section 300 to move the moving cam 310 and to start rotating the disc processing section 200 to the advanced position shown in FIG. 6A. When the optical disc 10 is loaded to the loading-completion position shown in FIG. 5, the sensor arm 431 is located at the standby position and the optical disc 10 is restricted from being moved. Since the optical disc 10 is located at the position, the rotating shaft 222A of the turn table 222 of the rotating disc processing section 200 is inserted and fit to the axial hole 10B opened substantially at the center of the optical disc 10 and the optical disc 10 is rotatably supported by the turn table 222 as shown in FIG. 6A.

In this state, when recognizing the request for reading processing that reads out information recorded on the recording surface 10A of the optical disc 10 or the request for recording processing that records information on the recording surface 10A, for example when recognizing the request signal output from the electric equipment, the control circuit appropriately operates the electric moving motor 232 and the pickup 242 for performing the reading processing or the recording processing.

On the other hand, when recognizing operation of the eject button for requesting ejection of the optical disc 10 or the ejection request signal of the optical disc 10 output from the electric equipment, the operating section controller recognizes the detection state of the optical disc 10 to be detected by the optical sensor 410. Then, the operating section controller sustains the standby state when recognizing that the optical sensor 410 does not detect the optical disc 10. If the pickup 242 is not located at the standby position, the control circuit drives the electric moving motor 232 to move the pickup 242 to the standby position.

Further, when recognizing that the optical sensor 410 detects the optical disc 10, the operating section controller drives the motor of the driving section 300 to move the moving cam 310 after the pickup 242 is moved to the standby position, and to rotate the disc processing section 200 to the retracted position shown in FIG. 6B. Because of that rotation, the rotating shaft 222A of the turn table 222 is released from the optical disc 10. After the disc processing section 200 is rotated, the operating section controller drives the loading motor and rotates the sensor arm 431 to push out the optical disc 10, so that the optical disc 10 is ejected from the opening as shown in FIG. 3. When the optical disc 10 is ejected from the opening, the optical sensor 410 is no longer able to sense the optical disc 10. Owing to this, the operating section controller determines that the optical disc 10 is not inserted, drives the loading motor to rotate the sensor arm 431 and to move to the standby position shown in FIG. 2. After that, the operating section controller drives the motor of the driving section 300 to move the moving cam 310 and to rotate the disc processing section 200 to the advanced position as shown in FIG. 6A, thereby becoming the insertion standby state for the optical disc 10.

(Advantages of First Embodiment)

As mentioned before, in the first embodiment, when recognizing that the optical disc 10 is not on the moving path during loading or ejection, or that the optical disc 10 is located at the loading-completion position which allows reading processing or recording processing using the pickup 242, the operating section controller of the control circuit rotates the disc processing section 200 so that the rotating shaft 222A of the turn table 222 is located at the advanced position on the moving path of the optical disc 10 as shown in FIG. 6A or 6C. Further, when recognizing that the optical disc 10 is moving or located on the moving path, the operating section controller rotates the disc processing section 200 so that the rotating shaft 222A of the turn table 222 is located at the retracted position retracted from the moving path for loading and ejecting the optical disc 10 as shown in FIG. 6B. For example, in the case where large impact is given to the disc drive 100 from the outside during the loading standby state of the optical disc 10, since the disc processing section 200 is located at the advanced position as shown in FIG. 6C, respective components, e.g. the impact-sensitive pickup 242 can be prevented from being damaged by crushing to the casing 110, even when the pickup 242 moves from the standby position toward the turn table 222 side. Accordingly, since the pickup 242 or the like can be prevented from being damaged even if the disc drive 100 is the thin slot-in type, the drive can easily be downsized.

When the optical sensor 410 detects the optical disc 10, the operating section controller rotates the disc processing section 200 so that the rotating shaft 222A of the turn table 222 is located at the retracted position retracted from the moving path of the optical disc 10 as shown in FIG. 6B. On the other hand, when recognizing that the sensor arm 431 is located at the standby position, the sensing switch 420 is turned off and the optical disc 10 is substantially located at the loading-completion position as shown in FIG. 5, or recognizing that the optical sensor 410 cannot detect the optical disc 10, the operating section controller rotates the disc processing section 200 so that the rotating shaft 222A of the turn table 222 is located at the advanced position advanced onto the moving path of the optical disc 10 as shown in FIG. 6A or 6C. Therefore, the simple configuration in which the optical sensor 410 and the sensing switch 420 are provided easily realizes such configuration capable of being downsized and preventing respective components from being damaged. Accordingly, the simple configuration easily allows to improve its manufacturability and to reduce its cost.

Additionally, the pickup 242 for information processing is integrally formed with the disc processing section 200 with the turn table 222 provided. When being rotated, the disc processing section 200 is controllably rotated to the advanced position or the retracted position according to the state of the optical disc 10. Owing to this, damages on the extremely impact-sensitive pickup 242 can surely be avoided.

Further, the optical sensor 410 is disposed near the opening at the position capable of sensing the optical disc 10 when the optical disc 10 is substantially located at the loading-completion position as shown in FIG. 5. The optical disc 10 can surely be detected not only immediately after the insertion from the opening, but also when, for instance, the axial hole 10B of the optical disc 10 is decentered. Accordingly, the position (translator's comment: of the disc processing section 200) can surely be controlled to the advanced position as shown in FIG. 6A or 6C in the insertion standby state for the optical disc 10 and in the state that the optical disc 10 is located at the loading-completion position, or to the retracted position in the state that the optical disc 10 is located on the moving path during loading or ejection.

Moreover, when recognizing the request signal that requests to eject the optical disc 10, the operating section controller moves the disc processing section 200 to the retracted position as shown in FIG. 6B after moving the pickup 242 to the standby position. Therefore, the pickup 242 would not crush to the casing 110 as the disc processing section 200 is rotated to the retracted position even when employing the thin structure, thus surely avoiding the damages on respective components.

### Second Embodiment

A second embodiment of the present invention will be described below with attached drawings. In the second embodiment, the optical sensor 410 according to the above first embodiment is disposed at the position near the opening, where the optical disc 10 cannot be detected when the optical disc 10 is located at the loading-completion position. Note that, the same numerals are applied to the same configurations as that of the first embodiment to omit those descriptions.

FIG. 7 is a plan view showing the configuration of a disc drive according to the second embodiment with a part thereof being cut.

(Configuration of Disc Drive)

The disc drive 500 is, as described above, arranged near the opening of the casing 110 at the position capable of immediately detecting the optical disc 10 to be inserted from the opening. The optical sensor 410 is also located at the position impossible to detect the optical disc 10 at the loading-completion position (see FIG. 5) where the pickup 242 performs information processing. In the same manner as the first embodiment, the optical sensor 410 detects is the presence of the optical disc 10 by detecting the outgoing light beam reflected by the optical disc 10, and outputs the signal indicating the detection to the operating section controller of the control circuit.

(Operation of Disc Drive)

The operating section controller of the control circuit in the disc drive 500 to which the electric power is supplied in the same way as the first embodiment determines the detection state of the optical disc 10, i.e. is the presence of the optical disc 10 according to the signal output from the optical sensor 410 When recognizing that the optical sensor 410 cannot detect the optical disc 10, the operating section controller, for instance, appropriately activates the electric rotating motor 221, the electric moving motor 232 and the pickup 242 to determine whether or not the pickup 242 can detect the outgoing light beam reflected by the optical disc 10. When the pickup 242 detects the signal from the optical disc 10, it is determined that the optical disc 10 is inserted, and the signal indicating the insertion of the optical disc 10 is output to the circuit controlling the operation of the electric equipment. On the other hand, when the pickup 242 cannot detect the signal from the optical disc 10, the operating section controller determines that the optical disc 10 is not inserted, thereby becoming the detection standby state for the optical disc 10 to be detected by the optical sensor 410. In the case where the pickup 242 is not located at the standby position, i.e. the rotation center side of the mount 210 which is the side opposite to the electric rotating motor 221, the control circuit drives the electric moving motor 232 to move the pickup 242 to the loading standby position.

If the optical sensor 410 detects the optical disc 10 in the loading standby state, the operating section controller generates, for example, flag information indicating the detection of the optical disc 10, and drives the motor of the driving section 300 to move the moving cam 310 and to rotate the disc processing section 200 to the same retracted position as that shown in FIG. 6B according to the first embodiment. Further, the operating section controller drives the loading motor to rotate the sensor arm 431 of the linking mechanism to the same position as that shown in FIG. 4 according to the first embodiment and also to rotate the loading arm inward. When recognizing that the sensing switch 420 is turned on due to rotation of the sensor arm 431, the operating section controller recognizes that the optical disc 10 is moving on the moving path during insertion or ejection, in other words, the optical disc 10 is located on the moving path.

If the optical disc 10 is pushed inside from the above-described state, the peripheral edge of the optical disc 10 contacts to the pulley of the sensor arm 431 in the same manner as shown in FIG. 6B according to the first embodiment. If the optical disc 10 is further pushed in this state, the sensor arm 431 and the loading arm are pushed out against the biasing force to be rotated outside. And if the optical disc 10 is pushed to the same position as that shown in FIG. 4 according to the first embodiment, the loading arm passes over the peripheral edge of the optical disc 10, and consequently, the biasing force is again applied to the loading arm to be rotated inward, so that the optical disc 10 is loaded to the loading-completion position by the biasing force.

When the optical disc 10 is loaded to the same loading-completion position as that shown in FIG. 5 according to the first embodiment, the sensor arm 431 is located at the standby position and the optical disc 10 is restricted from being moved. In this state, the optical sensor 410 is no longer able to detect the optical disc 10, and also, the sensing switch 420 is turned off. Owing to this, since the operating section controller has already generated the flag information, the operating section controller determines that the optical disc 10 is located at the loading-completion position, and generates second flag information. The operating section controller then drives the motor of the driving section 300 to move the moving cam 310 and to rotate the disc processing section 200 to the same advanced position as that shown in FIG. 6A according to the first embodiment. By the rotation, the rotating shaft 222A of the turn table 222 is inserted and fit to the axial hole 10B of the optical disc 10, and the optical disc 10 is rotatably supported by the turn table 222.

In this state, when recognizing the request for reading processing that reads out information recorded on the recording surface 10A of the optical disc 10 or the request for recording processing that records information on the recording surface 10A, for example when recognizing the request signal output from the electric equipment, the control circuit appropriately operates the electric moving motor 232 and the pickup 242 for performing the reading processing or the recording processing.

On the other hand, when recognizing operation of the eject button for requesting ejection of the optical disc 10 or the ejection request signal of the optical disc 10 output from the electric equipment, the operating section controller determines that the optical disc 10 is inserted because the second flag information is generated. If the pickup 242 is not located at the standby position, the operating section controller of the control circuit drives the electric moving motor 232 to move the pickup 242 to the standby position. Then, the motor of the driving section 300 is driven to move the moving cam 310, and the disc processing section 200 is rotated to the same retracted position as that shown in FIG. 6B. Because of that rotation, the rotating shaft 222A of the turn table 222 is released from the optical disc 10. After the disc processing section 200 is rotated, the operating section controller drives the loading motor and rotates the sensor arm 431 to push out the optical disc 10, so that the optical disc 10 is ejected from the opening in the same manner as shown in FIG. 4. Because the optical disc 10 is ejected, the optical sensor 410 detects the optical disc 10 again. Since the operating section controller detects the optical disc 10 while the second flag information is generated, the operating section controller determines that the optical disc 10 is ejected and deletes the second flag information. When the optical disc 10 is ejected from the opening, the optical sensor 410 is no longer able to sense the optical disc 10. Owing to this, the operating section controller determines that the optical disc 10 has been ejected, deletes the flag information, and drives the loading motor to rotate the sensor arm 431 to move to the same standby position as that shown in FIG. 6A. After that, the operating section controller drives the motor of the driving section 300 to move the moving cam 310 and to rotate the disc processing section 200 to the same advanced position as that shown in FIG. 6A, thereby becoming the insertion standby state for the optical disc 10.

(Advantages of Second Embodiment)

As described above, in the second embodiment, since the disc processing section 200 is rotated to the same retracted position as that shown in FIG. 6B when the optical disc 10 is located on the moving path, and the disc processing section 200 is rotated to the same advanced position as that shown in FIG. 6A or 6C when the optical disc 10 is not located on the moving path or the optical disc 10 is located at the loading-completion position, the respective components, e.g. the pickup 242 can be prevented from being damaged even when the thin slot-in type is employed, and the drive can easily be downsized in the same manner as the first embodiment.

Additionally, the optical sensor 410 is disposed near the opening at the position impossible to detect the optical disc 10 when the optical disc 10 is located at the loading-completion position. Therefore, it can easily be determined by the simple configuration that the optical disc 10 is on the moving path when the optical sensor 410 detects the optical disc 10, and that the optical disc 10 is not on the moving path or is located at the loading-completion position when the optical sensor 410 does not detect the optical disc 10. Accordingly, the configuration can easily be simplified, thus reducing in size and weight, improving manufacturability and reducing cost. Especially when the flag information is generated, it can easily be determined whether the optical disc 10 is not inserted or is located at the loading-completion position, thereby further simplifying the configuration even without the sensing switch 420.

Since the flag information is generated according to the detection state of the optical disc 10, the lading state of the optical disc 10 can surely be determined even when the optical sensor 410 cannot detect the optical disc 10 at the loading-completion position, thereby surely providing the configuration capable of avoiding damages on respective components and easily being downsized.

[Modifications]

Note that the present invention is not limited to the above embodiments but includes modifications as long as an object of the present invention can be attained.

Specifically, although the thin slot-in type configuration installed in the electric equipment using the optical disc 10 is described as the disc drive of the present invention, it is not limited thereto, and a configuration using any kind of disc recording medium, such as a magnetic disk or a magnetooptical disk capable of reproducing and recording information by way of light and magnet is also available. The configuration may not be installed in the electric equipment; and may independently function by itself. Additionally, the configuration may not be thin, and any slot-in type may be applicable.

Although the configuration is controlled by the operating section controller installed in the control circuit which controls the operation of the disc drive 100, 500, the operating section controller may be an independent circuit, a program or the like.

Although, the operating section controller rotates the disc processing section 200 to the front or retracted position in response to the optical sensor 410 and the sensing switch 420, any configuration can be used for detection. For example, the sensing switch 420 is not provided but flag information is generated as described in the second embodiment instead of providing both the optical sensor 410 and the sensing switch 420 in order to detect not only that the optical disc 10 is not on the moving path and is located at the loading-completion position, but also that the optical disc 10 is on the moving path.

Although the operating section controller controls operation to eject the optical disc 10 according to the request signal indicating the request of ejection, the request of ejection may be detected by an independently provided ejection detector to control the operation.

Although the pickup 242 is provided in the disc processing section 200, the disc processing section 200 may at least include the mount 210 and the turn table 222 rotatably supported by the casing 110, and the pickup 242 may be provided to the casing 110, for instance. Further, the disc processing section 200 may integrally be provided with a rotation configuration to function as the operating section of the present invention.

The configuration loading the optical disc 10 may not include the above-described linking mechanism, and any configuration that appropriately drives and rotates a rotor to load or eject the optical disc 10 may be employed.

Although the disc processing section 200 is rotated by driving the motor to move the moving cam 310, any configuration is available. For example, the disc processing section 200 is rotated by moving the moving cam 310 as the sensor arm 431 rotates. Without limiting to the configuration that rotates the disc processing section 200, any configuration that entirely slides or the like may be employed as long as the rotating shaft 222A of the turn table 222 is advanced onto and retracted from the moving path of the optical disc 10. Although the configuration in which the optical disc 10 is started to rotate when the optical disc 10 is located at the position just before the loading-completion position is described above, the rotation may be started after the optical disc 10 is located at the loading-completion position. In this configuration, since the rotation is started just before the loading-completion position and the rotating shaft 222A is inserted and fit to the axial hole 10B at the loading-completion position, operations proceed in parallel, thereby shortening the period of time necessary to start information processing and improving usability.

Although the rotating shaft 222A of the turn table 222 rotatably supports the optical disc 10, any configuration can be employed. For example, the optical disc 10 may be sandwiched by the turn table 222 and a rotor rotatably provided to the casing 110 using the magnetic force when the disc processing section 200 is rotated to the advanced position.

Specific structures and procedures for implementing the present invention can appropriately be changed to other structures or the like as long as an object of the present invention can be attained.

[Effects of Embodiments]

As described above, the operating section controller controls the rotating shaft 222A of the turn table 222 to move to the advanced position as shown in FIG. 6A or 6C advanced onto the moving path of the optical disc 10 when recognizing that the optical disc 10 is not on the moving path or the optical disc 10 is substantially located at the loading-completion position, and the operating section controller controls the rotating shaft 222A of the turn table 222 to move to the retracted position as shown in FIG. 6B retracted from the moving path when recognizing that the optical disc 10 is on the moving path. For example, in the case where large impact is given to the disc drive 100 from the outside during the loading standby state of the optical disc 10, since the disc processing section 200 is located at the advanced position as shown in FIG. 6C, respective components, e.g. the impact-sensitive pickup 242 can be prevented from being damaged by crushing to the thin casing 110 even when the pickup 242 moves from the standby position toward the turn table 222 side, and downsizing can easily be realized.

When the optical sensor 410 detects the optical disc 10, the rotating shaft 222A of the turn table 222 is controlled to be located at the same retracted position retracted from the moving path of the optical disc 10 as that shown in FIG. 6B. On the other hand, when it is recognized that the sensing switch 420 is turned off and the optical disc 10 is substantially located at the loading-completion position as shown in FIG. 5, or that the optical sensor 410 cannot detect the optical disc 10, the rotating shaft 222A of the turn table 222 is controlled to be located at the same advanced position advanced onto the moving path of the optical disc 10 as that shown in FIG. 6A or 6C. For example, in the case where large impact is given to the disc drive 100 from the outside during the loading standby state of the optical disc 10, since the disc processing section 200 is located at the same advanced position as that shown in FIG. 6C, respective components, e.g. the impact-sensitive pickup 242 can be prevented from being damaged by crushing to the thin casing 110 even when the pickup 242 moves from the standby position toward the turn table 222 side, and downsizing can easily be realized.

The priority application Number JP2004-099139 upon which this patent application is based is hereby incorporated by reference.

What is claimed is:

1. A disc drive, comprising:
a casing having an opening through which a disc recording medium is inserted or ejected;
an operating section disposed in the casing and having a supporting portion for rotatably supporting the disc recording medium, the supporting portion being advanced onto and retracted from a moving path of the disc recording medium;
an information processing section provided in the casing to perform an information processing of at least one of an information reading for reading out various pieces of information recorded on a recording surface of the disc recording medium and an information recording for recording various pieces of information on the recording surface;
a disc detector provided near the opening of the casing to detect is the presence of the disc recording medium;
a loading detector provided in the casing to detect that the disc recording medium is substantially located at a loading-completion position at which the information processing section can perform the information processing; and
an operating section controller that moves the operating section so that the supporting portion is retracted from the moving path when recognizing that the disc detector detects the disc recording medium and moves the operating section so that the supporting portion is advanced onto the moving path when recognizing that the loading detector detects the loading-completion position and that the disc detector cannot detect the disc recording medium.

2. The disc drive according to claim 1, wherein the disc detector is disposed at a position capable of detecting the disc recording medium when the disc recording medium is located on the moving path and at the loading-completion position.

3. A disc drive, comprising:
a casing having an opening through which a disc recording medium is inserted or ejected;
an operating section disposed in the casing and having a supporting portion for rotatably supporting the disc recording medium, the supporting portion being advanced onto and retracted from a moving path of the disc recording medium;
an information processing section provided in the casing to perform an information processing of at least one of an information reading for reading out various pieces of information recorded on a recording surface of the disc recording medium and an information recording of recording various pieces of information on the recording surface;
a disc detector disposed at a position near the opening of the casing where the disc recording medium is detected when the disc recording medium is located on the moving path and the disc recording medium cannot be detected when the disc recording medium is located at a loading-completion position where the information processing section can perform the information processing; and
an operating section controller that moves the operating section so that the supporting portion is retracted from the moving path when the disc detector detects the disc recording medium and moves the operating section so that the supporting portion is advanced onto the moving path when the disc detector cannot detect the disc recording medium.

4. The disc drive according to claim 1, further comprising:
an ejection detector provided in the casing to detect a request for ejecting the disc recording medium to the outside of the casing through the opening, wherein
the operating section controller controls the operating section so that the supporting section is retracted from the moving path when recognizing that the ejection detector detects the request for ejecting the disc recording medium.

5. The disc drive according to claim 3, further comprising:
an ejection detector provided in the casing to detect a request for ejecting the disc recording medium to the outside of the casing through the opening, wherein
the operating section controller controls the operating section so that the supporting section is retracted from the moving path when recognizing that the ejection detector detects the request for ejecting the disc recording medium.

6. A disc drive, comprising:
a casing having an opening through which a disc recording medium is inserted or ejected;
an operating section disposed in the casing and having a supporting portion for rotatably supporting the disc recording medium, the supporting portion being advanced onto and retracted from a moving path of the disc recording medium;
an information processing section provided in the casing to perform an information processing of at least one of an information reading for reading out various pieces of information recorded on a recording surface of the disc recording medium and an information recording for recording various pieces of information on the recording surface; and
an operating section controller that moves the operating section so that the supporting portion is advanced onto the moving path to rotatably support the disc recording medium when detecting that the disc recording medium is not on the moving path and the disc recording medium is located at a loading-completion position at which the information processing section can perform the information processing, and moves the operating section so that the supporting portion is retracted from the moving path when the disc recording medium is moving on the moving path.

7. The disc drive according to claim 6,
the operating section controller including:
a disc detector provided near the opening of the casing to detect the presence of the disc recording medium; and
a loading detector for detecting that the disc recording medium is substantially located at the loading-completion position at which the information processing section can perform the information processing, wherein
the operating section controller moves the operating section so that the supporting portion is retracted from the moving path when recognizing that the disc detector detects the disc recording medium and moves the operating section so that the supporting portion is advanced onto the moving path when recognizing that the loading detector detects the loading-completion position and that the disc detector cannot detects the disc recording medium.

8. The disc drive according to claim 6, wherein the disc detector is disposed at a position capable of detecting the disc recording medium when the disc recording medium is located on the moving path and the loading-completion position.

9. The disc drive according to claim 6,
the operating section controller including:
a loading detector for detecting that the disc recording medium is substantially located at a loading-completion position at which the information processing section can perform the information processing; and
a disc detector disposed at a position near the opening of the casing where the disc recording medium is detected when the disc recording medium is located on the moving path and the disc recording medium cannot be detected when the disc recording medium is substantially located at a loading-completion position, wherein
the operating section is moved so that the supporting portion is retracted from the moving path when the disc detector detects the disc recording medium and the operating section is moved so that the supporting portion is advanced onto the moving path when the disc detector cannot detect the disc recording medium.

10. The disc drive according to claim 6,
the operating section controller including:
an ejection detector provided in the casing to detect a request for ejecting the disc recording medium to the outside of the casing through the opening, wherein
the operating section is moved so that the supporting section is retracted from the moving path when recognizing that the ejection detector detects the request for ejecting the disc recording medium.

11. The disc drive according to claim 1, wherein
the operating section provided with the supporting portion near a peripheral edge thereof includes a rotating body rotatably supported by the casing to rotate around a rotation end on a side where the supporting portion is provided and at a position near the peripheral edge on a side opposite to the position where the supporting portion is provided, and a driving section that rotates the rotating body so that the supporting portion is advanced onto and retracted from the moving path, and
the information processing section is disposed on the rotating body movable to be near the supporting portion without contacting to the casing while the rotating body is rotated so that the supporting portion is retracted from the moving path.

12. The disc drive according to claim 3, wherein
the operating section provided with the supporting portion near a peripheral edge thereof includes a rotating body rotatably supported by the casing to rotate around a rotation end on a side where the supporting portion is provided and at a position near the peripheral edge on a side opposite to the position where the supporting portion is provided, and a driving section that rotates the rotating body so that the supporting portion is advanced onto and retracted from the moving path, and
the information processing section is disposed on the rotating body movable to be near the supporting portion without contacting to the casing while the rotating body is rotated so that the supporting portion is retracted from the moving path.

13. The disc drive according to claim 6, wherein
the operating section provided with the supporting portion near a peripheral edge thereof includes a rotating body rotatably supported by the casing to rotate around a rotation end on a side where the supporting portion is provided and at a position near the peripheral edge on a side opposite to the position where the supporting portion is provided, and a driving section that rotates the rotating body so that the supporting portion is advanced onto and retracted from the moving path, and
the information processing section is disposed on the rotating body movable to be near the supporting portion without contacting to the casing while the rotating body is rotated so that the supporting portion is retracted from the moving path.

14. A slot-in type disc drive, comprising:
a disc sensor provided near an opening to sense whether a disc is inserted or not;
a loading detector that senses loading-completion state of the disc;
a disc loading and unloading determiner that determines whether the disc is inserted or ejected according to a detection result by the disc sensor whether the disc is inserted or not and by the loading detector whether the disc loading is completed or not; and
a supporting portion rotatably supporting the disc, wherein
the supporting portion is retracted when the insertion of the disc is sensed, and is advanced when the ejection of the disc is sensed by the disc loading and unloading unit (translator's comment: correctly, disc loading and unloading determiner).
